(19) United States
(12) Patent Application Publication
(10) Pub. No.: US 2010/0029460 A1
(43) Pub. Date: Feb. 4, 2010

(54) GLASS FOR ANODIC BONDING

(75) Inventors: Masanori Shojiya, Tokyo (JP); Hirotaka Koyo, Tokyo (JP); Koichi Sakaguchi, Tokyo (JP); Satoshi Jibiki, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: NIPPON SHEET GLASS COMPANY, LIMITED, Tokyo (JP)

(21) Appl. No.: 12/527,308

(22) PCT Filed: Feb. 21, 2008
(86) PCT No.: PCT/JP2008/052977

§ 371 Date: Aug. 14, 2009

(30) Foreign Application Priority Data
Feb. 22, 2007 (JP) 2007-042621

(51) Int. Cl. C03C 3/093; C03C 3/095; C03C 15/00

(52) U.S. Cl. 501/64; 501/66; 501/67; 216/87

(57) ABSTRACT

The present invention provides a glass for anodic bonding having a low thermal expansion coefficient and capable of being subjected to laser beam micromachining. The present invention is a glass for anodic bonding having a base glass composition containing 1 to 6 mol % of Li₂O+Na₂O+K₂O and having an average linear expansion coefficient of 32×10⁻⁷ K⁻¹ to 39×10⁻⁷ K⁻¹ in a temperature range of room temperature to 450° C. This glass further contains 0.01 to 5 mol % of a metal oxide as a colorant relative to the base glass composition, and has an absorption coefficient of 0.5 to 50 cm⁻¹ at a particular wavelength within 535 nm or less.

### TECHNICAL FIELD

The present invention relates to a glass for anodic bonding that can be bonded anodically to silicon and can be subjected to micromachining by laser beam irradiation and etching.

### BACKGROUND ART

Mainly in the fields of automobiles, cellular phones and biochemistry, devices called MEMS (Micro-Electro-Mechanical Systems) fabricated using various semiconductor fabrication techniques have been used increasingly in recent years. Not only have MEMS devices such as acceleration sensors and pressure sensors already been applied to automobiles and the like, but also optical MEMS devices such as optical waveguide sensors and optical switching devices have been used in increasingly diverse applications.

Glass, as one of the components of these MEMS devices, is used widely for applications such as electrically insulating substrates and supports for supporting silicon. In MEMS devices, glass often is bonded to silicon by so-called “anodic bonding” without using any adhesive.

Anodic bonding is a method of bonding glass to silicon. In this method, glass and silicon are brought into contact with each other and a high voltage of about several hundred V to 1 kV is applied across them using the silicon as an anode while heating them at about 300 to 450° C. This causes easily mobile cations (alkali metal ions) contained in the glass to move toward the cathode, and as a result, a firm bond is created electrostatically and chemically at the interface between the glass and the silicon.

As described above, the glass and the silicon need to be heated at several hundred degrees centigrade in the anodic bonding process, and therefore it is desirable that the glass to be used for MEMS devices have thermal expansion characteristics that match those of the silicon as closely as possible. The reason for this is as follows. If there is a significant difference in the thermal expansion characteristics between the silicon and the glass, they contract at different rates when they are cooled down to room temperature after the completion of the anodic bonding process. This results in significant residual stress at the bonded interface that may cause damage to the component members. Such a significant residual stress at the interface, even if it may not cause damage, may affect adversely the strength and the properties of the MEMS devices as finished products.

With these points being taken into consideration, glasses to be used for anodic bonding are limited to low expansion glasses containing suitable amounts of alkali metal ions in the composition and having thermal expansion characteristics that almost match those of silicon over a temperature range of room temperature to several hundred degrees centigrade.

Pyrex (registered trademark) glasses having average linear thermal expansion coefficients of about 32×10⁻⁷ K⁻¹ to 33×10⁻⁷ K⁻¹ in a temperature range of room temperature to about 450° C. are used widely for MEMS devices. There also have been known “glasses for anodic bonding” having temperature dependencies of thermal expansion characteristics that match those of silicon more closely than Pyrex (registered trademark) glasses. Such glasses include, for example, those disclosed in JP 04(1992)-83733 A, JP 07(1995)-53235 A, and JP 2001-72433 A.

Furthermore, the present inventors have proposed a glass for laser beam machining in JP 2005-67908 A. This glass consists of a soda lime silicate glass having a composition containing 74SiO₂+10CaO+16Na₂O, where each number denotes a molar ratio, and further containing at least one element of iron, cerium and tin.

In many cases, glasses to be used for MEMS devices need to have fine through-holes so as to ensure electrical conductivity. In order to form fine through-holes, laser beam machining can be used conceivably. However, the possible use of such laser beam machining has not necessarily been considered in the above-mentioned “glasses for anodic bonding”.

### DISCLOSURE OF THE INVENTION

Accordingly, it is an object of the present invention to provide a glass for anodic bonding having a low thermal expansion coefficient and capable of being subjected to laser beam micromachining. It is another object of the present invention to provide a method of producing a glass for anodic bonding having a micro-hole by using a laser beam.

The present invention is a glass for anodic bonding having a base glass composition containing 1 to 6 mol % of Li₂O+Na₂O+K₂O and having an average linear expansion coefficient of 32×10⁻⁷ K⁻¹ to 39×10⁻⁷ K⁻¹ in a temperature range of room temperature to 450° C. This glass further contains 0.01 to 5 mol % of a metal oxide as a colorant relative to the base glass composition, and has an absorption coefficient of 0.5 to 50 cm⁻¹ at a particular wavelength within 535 nm or less.

In another aspect, the present invention is a method of producing a glass for anodic bonding having a micro-hole. This method includes the steps of producing this glass for anodic bonding as a glass plate; irradiating a laser beam onto a surface of the glass plate so as to form an altered phase; and wet-etching the glass with the altered phase formed therein so as to form a micro-hole in the glass.

### BRIEF DESCRIPTION OF THE DRAWING

FIG. 1 is a photograph showing a cross section of a glass of Example 5, observed with an optical microscope after the glass was irradiated with a laser beam and etched.

### BEST MODE FOR CARRYING OUT THE INVENTION

The glass of the present invention is a glass for anodic bonding, and contains 1 to 6 mol % of Li₂O+Na₂O+K₂O in its base glass composition.

These alkali metal oxides (Li₂O, Na₂O and K₂O) are glass network modifiers and essential components for glasses for anodic bonding. In anodic bonding, Li⁺, Na⁺ and K⁺ ions contained in these alkali metal oxides move toward the cathode, which causes formation of covalent bonds between non-bridging oxygen ions in the glass and silicon at the interface therebetween. Since Li⁺ and Na⁺ ions are easily mobile in particular, it is preferable that the base glass composition contains at least either one of Li₂O and Na₂O.

The lower limit of the total content of (Li₂O+Na₂O+K₂O) is 1 mol % in order to disrupt the glass network suitably, lower the melting temperature, and keep the viscosity of the glass melt low. On the other hand, the upper limit of the total content thereof is 6 mol % in order to prevent the thermal expansion coefficient from increasing and achieve the anodic bonding with silicon. Accordingly, the total content of (Li₂O+Na₂O+K₂O) is in a range of 1 to 6 mol %.

It is desirable that glasses for anodic bonding have thermal expansion characteristics similar to those of silicon. Hence, the glass for anodic bonding of the present invention has an average linear expansion coefficient of 32×10⁻⁷ K⁻¹ to 39×10⁻⁷ K⁻¹ in a temperature range of room temperature to 450° C.

This average linear expansion coefficient can be obtained by measuring with a differential thermal expansion meter the expansion rate of a test sample in a temperature range of room temperature to 450° C. and dividing this expansion rate by a value of temperature change.

The glass for anodic bonding of the present invention contains a metal oxide as a colorant, in addition to the base glass composition, in order to increase the absorption coefficient of the glass at a particular wavelength. Preferably, the glass contains, as the colorant, at least one selected from the group consisting of tin oxide, cerium oxide, iron oxide, titanium oxide, vanadium oxide, chromium oxide, manganese oxide, cobalt oxide, molybdenum oxide, tungsten oxide, and bismuth oxide. More preferably, the glass contains at least one selected from the group consisting of tin oxide, cerium oxide, and iron oxide. These metal oxides are added to the base glass composition so that the total content of the metal oxides is 0.01 to 5 mol % relative to the base glass composition.

The glass containing these metal oxides serving as colorants can have an absorption coefficient of 0.5 to 50 cm⁻¹ at a particular wavelength within 535 nm or less. It should be noted that the content of iron oxide is calculated in terms of Fe₂O₃.

A glass containing only either one of cerium oxide and iron oxide as a colorant is vitrified easily. Furthermore, the addition of these metal oxides is preferable in producing glass because the refining effect (release of oxygen due to a change in the valence of metal ions) of each of these oxides is expected to be effective in accelerating the refining of the glass melt. In order to produce the glass that satisfies the condition of the absorption coefficient and is suitable for micromachining, it is preferable that the glass contains 0.1 to 0.5 mol % of cerium oxide in terms of CeO₂ when the cerium oxide is present, and that the glass contains 0.05 to 0.2 mol % of iron oxide in terms of Fe₂O₃ when the iron oxide is present.

The glass for anodic bonding of the present invention has an absorption coefficient of 0.5 to 50 cm⁻¹ at a particular wavelength within 535 nm or less. This particular wavelength is equal to the wavelength of a laser beam to be used in machining for forming a micro-hole on the surface of the glass for anodic bonding. When the absorption coefficient is less than 0.5 cm⁻¹, an interaction is not induced between the glass and the laser beam, which makes it difficult to form an altered phase required for etching to be described later.

Even in a glass having an excessively small absorption coefficient, an altered phase may be formed in some cases if the glass is irradiated with a very high power laser beam. In most of these cases, however, the applied energy is excessively large, and thus a shock wave or a plasma is generated, which causes damage around the laser beam irradiation spot. Such a damaged glass is not suitable for being subjected to etching.

On the other hand, when the absorption coefficient is greater than 50 cm⁻¹, the energy of the laser beam is absorbed only in the vicinity of the laser beam incoming surface of the glass, which causes ablation thereof. Accordingly, an altered phase suitable for being etched cannot be formed inside the glass.

Preferably, the absorption coefficient is 0.5 to 30 cm⁻¹, more preferably 1 to 15 cm⁻¹, and further preferably 1.5 to 10 cm⁻¹.

The absorption coefficient can be calculated in the following manner. The light transmittance T1 of a sample with a thickness of d1 and the light transmittance T2 of a sample with a thickness of d2 are obtained at a particular wavelength by measuring their light transmission spectra. Then, their absorption coefficients are calculated from α=ln(T1/T2)/(d2−d1) (where ln is a natural logarithm) according to the Lambert's law.

As long as the absorption coefficient of the glass is in a range of 0.5 to 50 cm⁻¹ at one particular wavelength within 535 nm or less, it may be any value at a wavelength other than the particular wavelength. It is preferable in the glass for anodic bonding of the present invention that the particular wavelength at which the glass has an absorption coefficient of 0.5 to 50 cm⁻¹ is the wavelength of a laser beam emitted from a currently utilized laser apparatus (see the production method to be described later). Preferably, the particular wavelength is within 400 nm or less, more preferably 360 nm or less, and further preferably in a range of 350 to 360 nm.

Generally, a glass composition suitable for anodic bonding is different from a glass composition suitable for forming an altered phase by laser beam irradiation and wet-etching the altered phase so as to form a micro-hole. As described above, monovalent cations such as Li⁺, Na⁺ and K⁺ move while an electric field is applied to a glass and the glass changes in its structure near the surface thereof in the vicinity of the anode, which induces an anodic bond. When metal ions (cations) as a colorant are added to the glass, these metal ions also change the behavior of the above-mentioned monovalent cations that are involved directly in anodic bonding.

For example, when iron oxide is added to a glass to increase its absorption of ultraviolet light, the iron ions are present in the form of Fe³⁺ and Fe²⁺ in the glass. In this case, monovalent cations in some glass compositions convert six-coordinate Fe³⁺ into four-coordinate Fe³⁺ so as to facilitate the entry of Fe³⁺ into the glass network structure. In this state, both the iron ions and the monovalent cations compensate for the charges each other and a strong interaction is established therebetween. This change of state may affect significantly the behavior of the monovalent cations when the electric field is applied.

For example, generally, when metal ions having a valence of 2 or higher and capable of existing in two or more valence states are added to a glass, even if only in a small amount, they have a significant effect on the glass structure. The above-mentioned colorants each have a valence of 2 or higher, and most of them can exist in two or more valence states. Therefore, they have a significant effect on the glass structure. As a result, the formation of an altered phase, that is, the structural change of the glass during laser irradiation also is affected significantly.

Furthermore, the abundance ratio (redox state) of ions having different valences has a significant effect on the quality of the glass such as degassing. Typical examples of these colorants include cerium oxide (in the form of Ce³⁺ and Ce⁴⁺ as metal ions in a glass) and tin oxide (in the form of Sn²⁺ and Sn⁴⁺ as metal ions in a glass).

Accordingly, in order to allow a glass containing a colorant to be a glass for anodic bonding capable of being subjected to laser beam micromachining, its base glass composition is required to have the characteristics (anodic bondability and thermal expansion characteristics) and the quality suitable for the glass for anodic bonding. Therefore, in order to establish a glass for anodic bonding containing a metal oxide as a colorant, a base glass composition thereof needs to be formulated.

As a result of intensive studies of the compositions of glasses for anodic bonding, the present inventors have found that the following base compositions are suitable as base compositions of the glass for anodic bonding containing any of the above-mentioned colorants: (1) a borosilicate glass-based base composition; (2) an aluminosilicate glass-based base composition; and (3) an aluminoborosilicate glass-based base composition. It should be noted that, in the following compositions, “%” denotes “mol %”.

(1) Borosilicate Glass-Based Base Composition

The first base composition suitable for the glass for anodic bonding of the present invention contains:
80 to 85% of SiO₂;
10 to 15% of B₂O₃;
0 to 5% of Al₂O₃;
0 to 5% of CaO+MgO+SrO+BaO+ZnO, and
1 to 6% of Li₂O+Na₂O+K₂O.

SiO₂ is an essential component for forming the network of the glass. The content of SiO₂ in this glass composition is 80 to 85%, and preferably 82 to 83%, in order to vitrify the composition without causing phase separation and crystallization.

B₂O₃ is an essential component for forming the network of the glass. The content of B₂O₃ in this glass composition is 10 to 15%, and preferably 11 to 12%, in order to vitrify the composition without causing phase separation and crystallization.

In this borosilicate-based glass, Al₂O₃ is an optional component serving as an intermediate between a glass network former and a glass network modifier. Al₂O₃ is a component that contributes to improvements in the stability and chemical durability of glass, as well as to a decrease in the thermal expansion coefficient thereof. The content of Al₂O₃ is therefore up to 5%, and preferably 1 to 2%.

Alkaline earth metal oxides, namely, MgO, CaO, SrO and BaO (hereinafter referred to simply as alkaline earth metal oxides) are optional components for modifying the network of the glass. These alkaline earth metal oxides are components for improving the meltability of the glass. ZnO is an optional component having the same effect as the alkaline earth metal oxides. Generally, ZnO also is a component for improving the glass formation ability. The total content of the alkaline earth metal oxides and ZnO can be up to 5% in order to vitrify the composition and to achieve a low thermal expansion coefficient, and preferably it is 0%.

The content of (Li₂O+Na₂O+K₂O) is in a range of 1 to 6%, as described above, and preferably it is 4 to 5%.

Preferably, the borosilicate glass-based base composition contains:
82 to 83% of SiO₂;
11 to 12% of B₂O₃;
1 to 2% of Al₂O₃; and
4 to 5% of Li₂O+Na₂O+K₂O.

It is preferable that the glass for anodic bonding having the borosilicate glass-based base composition has an average linear expansion coefficient of 32×10⁻⁷ K⁻¹ to 34×10⁻⁷ K⁻¹.

(2) Aluminosilicate Glass-Based Base Composition

The second base composition suitable for the glass for anodic bonding of the present invention contains:
60 to 70% of SiO₂;
0 to 8% of B₂O₃;
10 to 16% of Al₂O₃;
5 to 20% of CaO+MgO+SrO+BaO+ZnO; and
1 to 6% of Li₂O+Na₂O+K₂O.

SiO₂ is an essential component for forming the network of the glass. The content of SiO₂ in this glass composition is 60 to 70%, and preferably 65 to 67%, in order to vitrify the composition and to achieve a low thermal expansion coefficient.

B₂O₃ is an optional component for forming the network of the glass. The content of B₂O₃ in this glass composition is up to 8%, and preferably 0%, in order to improve the glass formation ability and to lower the high-temperature viscosity so as to achieve and improve the meltability.

In this alminosilicate glass, Al₂O₃, which is an intermediate oxide, is an essential component. The content of Al₂O₃ is 10 to 16% in order to vitrify the composition and to achieve a low thermal expansion coefficient.

The total content of the alkaline earth metal oxides and ZnO is 5 to 20% in order to vitrify the composition and to achieve a low thermal expansion coefficient. Preferably, the content of ZnO is at least 1% in order to achieve a low thermal expansion coefficient while improving the stability and meltability of the glass. Preferably, the total content of the alkaline earth metal oxides and ZnO is 15 to 16%.

The content of (Li₂O+Na₂O+K₂O) is in a range of 1 to 6%, as described above, and preferably it is 2 to 4%.

Preferably, the aluminosilicate glass-based base composition contains:
65 to 67% of SiO₂;
10 to 16% of Al₂O₃;
15 to 16% of MgO+ZnO; and
2 to 4% of Li₂O+Na₂O+K₂O.

It is preferable that the glass for anodic bonding having the aluminosilicate glass-based base composition has an average linear expansion coefficient of 32×10⁻⁷ K⁻¹ to 36×10⁻⁷ K⁻¹.

(3) Aluminoborosilicate Glass-Based Base Composition

The third base composition suitable for the glass for anodic bonding of the present invention contains:
25 to 55% of SiO₂;
20 to 45% of B₂O₃;
15 to 25% of Al₂O₃;
3 to 18% of CaO+MgO+SrO+BaO+ZnO; and
1 to 6% of Li₂O+Na₂O+K₂O.

SiO₂ is an essential component for forming the network of the glass. The content of SiO₂ in this glass composition is 25 to 55% in order to vitrify the composition and to achieve a low thermal expansion coefficient.

B₂O₃ is an essential component for forming the network of the glass. The content of B₂O₃ in this glass composition is 20 to 45% in order to vitrify the composition and to achieve a low thermal expansion coefficient as well as to achieve the stability and chemical durability of the glass.

Al₂O₃ is an essential component that serves as an intermediate oxide in this glass composition. The content of Al₂O₃ is 15 to 25% in order to vitrify the composition and to achieve a low thermal expansion coefficient. Particularly in order to enable vitrification by fusion, the content of Al₂O₃ is 25% or less.

It is desirable that in this aluminoborosilicate glass, the ratio of B₂O₃ to SiO₂ in terms of mol % (B₂O₃/SiO₂ ratio) be less than about 1.5. This is because an excellent altered phase can be formed easily in this glass when it is irradiated with a laser beam.

The total content of the alkaline earth metal oxides and ZnO may be 3 to 18%. Among them, ZnO is very effective in achieving a low thermal expansion coefficient while improving the stability and meltability of the glass, and therefore, the content thereof is particularly preferably at least 1%. On the other hand, it is particularly preferable that the content of MgO is 10% or less in order to achieve the resistance to devitrification of the glass.

The content of (Li₂O+Na₂O+K₂O) is in a range of 1 to 6%, as described above.

Since there is a constraint that the total content of the respective components of the glass base composition must be 100%, even a glass falling within a composition range of any of the above three base compositions may not satisfy the average linear expansion coefficient of 32×10⁻⁷ K⁻¹ to 39×10⁻⁷ K⁻¹ in a temperature range of room temperature to 450° C.

This average linear expansion coefficient is, however, one of the constituent features of the present invention for its technical significance of a property required as a glass for anodic bonding. Therefore, a glass that falls within this composition range but does not satisfy the condition of this average linear expansion coefficient is not included in the scope of the present invention.

For the production of the glass having an average linear expansion coefficient of 32×10⁻⁷ K⁻¹ to 39×10⁻⁷ K⁻¹, please see Examples below in addition to the above-mentioned base compositions. For the more reliable production, the preferable range of the base compositions (1) and (2) can be selected.

In order to obtain the glass for anodic bonding of the present invention, a small amount of a generally known refining agent, for example, chloride (such as NaCl), fluoride (such as CaF₂), arsenious acid, and antimony oxide may be added to the raw materials.

Even if sulfate such as mirabilite, nitrate as an oxidizing agent, carbon as a reducing agent, and other additives are added to the raw materials in order to improve the solubility of the raw materials, accelerate the refining action, and adjust the absorption coefficient of the glass, and trace amounts of these components remain in the finished glass, no problem is posed as long as the average linear expansion coefficients and the absorption coefficients satisfies the conditions of the ranges defined by the present invention.

Since the glass for anodic bonding of the present invention has thermal expansion characteristics similar to those of silicon, it is free from a problem of residual stress after the anodic bonding. In addition, since the glass of the present invention contains a suitable amount of alkali metal ions, it can be used for anodic bonding to silicon in the same manner as in the conventional glasses for anodic bonding. Furthermore, since the glass of the present invention contains a colorant component and exhibits an absorption of light having a particular wavelength, an altered phase can be formed in the glass by irradiating a laser beam having the particular wavelength. The glass can be micromachined easily by removing this altered phase by etching. Accordingly, the glass for anodic bonding of the present invention can be subjected easily to laser beam micromachining.

The glass for anodic bonding of the present invention can be produced in the conventional manner. For example, the glass of the present invention can be produced by mixing glass raw materials according to the above-mentioned base glass compositions and the contents of colorants, melting the mixture, and then forming the resulting mixture into a suitable shape. As these glass raw materials, commonly-used glass raw materials may be used.

Among the glasses for anodic bonding, glasses for anodic bonding having micro-holes are very useful for MEMS applications. Accordingly, another aspect of the present invention is a method of producing a glass for anodic bonding having a micro-hole. This method includes the steps of producing the glass for anodic bonding as a glass plate (Step 1); irradiating a laser beam onto a surface of the glass plate so as to form an altered phase (Step 2); and wet-etching the glass with the altered phase formed therein so as to form a micro-hole in the glass.

Step 1 can be carried out, in the conventional manner, by mixing glass raw materials according to the above-mentioned base glass compositions and the contents of colorants, melting the mixture, and then forming the resulting mixture into a plate shape.

In Step 2, the altered phase is formed by irradiating a laser beam. Although the detailed mechanism of how the altered phase is formed has not been clear, it is believed that light excitation (i.e., multi-photon absorption) needs to reach the absorption edge of the glass in order to form the altered phase by irradiating the glass for anodic bonding with a laser beam. For this purpose, a laser beam having a wavelength of 535 nm or less, rather than a near-infrared laser beam or an infrared laser beam, is very advantageous in forming the altered phase.

The wavelength of a laser beam to be used should be a wavelength that allows the glass for anodic bonding to have an absorption coefficient of 0.5 to 50 cm⁻¹. This wavelength is 535 nm or less. Particularly, the laser beam is preferably ultraviolet light of 400 nm or less, and more preferably ultraviolet light of 360 nm or less. For example, the second, third, and fourth harmonics of an Nd:YAG laser, an Nd:YLF laser, or an Nd:YVO₄ laser have wavelengths in the vicinity of 532 to 535 nm, 355 to 357 nm, and 266 to 268 nm, respectively. The wavelength of a KrF excimer laser is in the vicinity of 248 nm. Such laser beams having short wavelengths are used because the experimental results have shown that they facilitate the formation of the altered phase in the glass. A particularly suitable laser beam wavelength is in a range of 350 to 360 nm, and the third harmonic of the Nd:YAG laser can be used for obtaining such a suitable wavelength.

The laser beam irradiation can be performed according to a known method. For example, the laser beam irradiation can be performed according to the method described in WO 2007/096958 A1.

An “altered phase” means here an altered phase without any damage such as cracking and chipping around the laser irradiation spot. If a portion around the laser irradiation spot is damaged, the glass melts along the damaged portion during the subsequent etching process, which results in irregularity or unevenness in the shape of the finished glass. The altered phase can be confirmed visually because the refractive index of the altered phase is different from that of the surrounding portion or the color of the altered phase is different from that of the surrounding portion due to coloration.

In Step 3, the altered phase is removed by wet-etching so as to form a micro-hole.

As an etchant for wet-etching, an etchant having a greater etching rate for the altered phase than that for the unaltered portion of the glass is used. Examples of such an etchant include hydrofluoric acid, sulfuric acid, hydrochloric acid, nitric acid, and mixed acid of these. Among them, hydrofluoric acid is used preferably because the etching of the altered phase can proceed faster and the micro-hole can be formed in a shorter period of time.

The concentration of acid in the etchant, etching time, and etching temperature are selected according to the shape of the altered phase and the intended shape of the product glass. The speed of etching can be increased by increasing the etching temperature. It is also possible to control the diameter of the micro-hole according to the etching conditions.

According to the production method of the present invention, the micro-hole can be formed also as a through-hole. Furthermore, it is also possible to apply the production method of the present invention so as to form various shapes such as a grooved shape in the surface of the glass for anodic bonding.

When a through-hole is formed by the production method of the present invention, it is desirable to form the altered phase across the thickness direction of the glass for anodic bonding. Therefore, it is recommended that the absorption coefficient of the glass for anodic bonding be adjusted suitably in order to prevent the irradiated laser beam from being absorbed only in the vicinity of the surface of the glass.

The following will describe the present invention in detail based on Examples. The present invention is not limited to these Examples.

### Examples 1 to 18 and Comparative Examples 1 and 2

In Examples 1 to 18, glasses each having the above-mentioned borosilicate glass-based base composition (1) were used. Commonly used glass raw materials such as oxides and carbonates were weighed and mixed so that 400 g of each glass having the glass composition indicated in Table 1 would be obtained. Thus, each batch was prepared. It should be noted that this glass composition was prepared so that the total amount of the components of only the base glass composition except metal oxides as colorants was 100 mol %, and the metal oxides as colorants were added at ratios of the values (mol %) indicated in Table 1 to the base glass composition.

TABLE 1

| | | | | | | | | | | Example |
|---|---|---|---|---|---|---|---|---|---|---|
| Components | Example 1 | Example 2 | Example 3 | Example 4 | Example 5 | Example 6 | Example 7 | Example 8 | Example 9 | 10 |
| SiO₂ | 82.7 | 82.7 | 82.7 | 82.7 | 82.7 | 82.7 | 82.7 | 82.7 | 82.7 | 82.7 |
| B₂O₃ | 11.6 | 11.6 | 11.6 | 11.6 | 11.6 | 11.6 | 11.6 | 11.6 | 11.6 | 11.6 |
| Al₂O₃ | 1.4 | 1.4 | 1.4 | 1.4 | 1.4 | 1.4 | 1.4 | 1.4 | 1.4 | 1.4 |
| Li₂O | 0.0 | 0.0 | 0.0 | 0.0 | 0.0 | 0.0 | 0.0 | 0.0 | 1.4 | 2.2 |
| Na₂O | 3.5 | 3.5 | 3.5 | 3.5 | 3.5 | 3.5 | 3.5 | 2.2 | 1.4 | 0.0 |
| K₂O | 0.8 | 0.8 | 0.8 | 0.8 | 0.8 | 0.8 | 0.8 | 2.2 | 1.4 | 2.2 |
| SnO₂ | 0.0 | 0.0 | 0.0 | 0.2 | 0.5 | 0.5 | 1.0 | 1.0 | 1.0 | 1.0 |
| CeO₂ | 0.1 | 0.2 | 0.4 | 0.0 | 0.0 | 0.2 | 0.2 | 0.2 | 0.2 | 0.2 |
| Fe₂O₃ | 0.0 | 0.0 | 0.0 | 0.0 | 0.0 | 0.0 | 0.0 | 0.0 | 0.0 | 0.0 |
| Absorption | 3.5 | 9.5 | 26.7 | 0.5 | 1.3 | 14.0 | 18.0 | 18.0 | 18.0 | 18.0 |
| coefficient (cm⁻¹) | | | | | | | | | | |
| Linear expansion | 32 | 32 | 32 | 32 | 32 | 32 | 33 | 32 | 32 | 32 |
| coefficient | | | | | | | | | | |
| (10⁻⁷/K⁻¹) | | | | | | | | | | |
| Formation of | Δ | [symbol] | Δ | ∘ | ∘ | [symbol] | [symbol] | [symbol] | [symbol] | [symbol] |
| altered phase | | | | | | | | | | |
| | Example | Example | Example | Example | Example | Example | Example | Example | Comp. | Comp. |
| Components | 11 | 12 | 13 | 14 | 15 | 16 | 17 | 18 | Example 1 | Example 2 |
| SiO₂ | 82.7 | 82.7 | 82.7 | 82.7 | 82.7 | 82.7 | 82.7 | 82.7 | 82.7 | 100.0 |
| B₂O₃ | 11.6 | 11.6 | 11.6 | 11.6 | 11.6 | 11.6 | 11.6 | 11.6 | 11.6 | 0.0 |
| Al₂O₃ | 1.4 | 1.4 | 1.4 | 1.4 | 1.4 | 1.4 | 1.4 | 1.4 | 1.4 | 0.0 |
| Li₂O | 2.0 | 2.0 | 2.0 | 2.0 | 0.0 | 0.0 | 0.0 | 0.0 | 0.0 | 0.0 |
| Na₂O | 0.3 | 0.3 | 0.3 | 0.3 | 3.5 | 3.5 | 3.5 | 3.5 | 3.5 | 0.0 |
| K₂O | 2.0 | 2.0 | 2.0 | 2.0 | 0.8 | 0.8 | 0.8 | 0.8 | 0.8 | 0.0 |
| SnO₂ | 1.0 | 1.5 | 1.0 | 1.5 | 0.00 | 0.00 | 0.00 | 0.00 | 0.0 | 0.0 |
| CeO₂ | 0.2 | 0.2 | 0.5 | 0.5 | 0.04 | 0.08 | 0.20 | 0.04 | 0.0 | 0.0 |
| Fe₂O₃ | 0.0 | 0.0 | 0.0 | 0.0 | 0.01 | 0.02 | 0.05 | 0.02 | 0.0 | 0.0 |
| Absorption | 18.0 | 21.9 | 41.5 | 45.5 | 2.2 | 5.1 | 18.8 | 3.0 | 0.1 to 0.2 | 0.0 |
| coefficient (cm⁻¹) | | | | | | | | | | |
| Linear expansion | 33 | 34 | 32 | 34 | 32 | 32 | 32 | 32 | 32 | 5 |
| coefficient | | | | | | | | | | |
| (10⁻⁷/K⁻¹) | | | | | | | | | | |
| Formation of | [symbol] | [symbol] | ∘ | ∘ | ∘ | ∘ | ∘ | ∘ | x | xx |
| altered phase | | | | | | | | | | |

The batch was put into a platinum crucible, and melted for 12 to 24 hours in an electric furnace at 1550 to 1620° C. while being stirred as appropriate. The resulting melt was poured into a carbon or stainless steel mold, and maintained at a predetermined temperature for several hours so as to remove distortion, followed by cooling slowly to room temperature. Thus, each bulk glass was obtained.

Comparative Example 1 is an embodiment in which a glass has the same borosilicate glass-based base composition (as that of Examples 1 to 7 and 15 to 18) and contains no metal oxide as a colorant. Comparative Example 2 is an embodiment in which a glass is a quartz glass (100% SiO₂) and thus contains no colorant.

From the bulk glass thus obtained, a test sample for measuring the thermal expansion coefficient was cut out, and the thermal expansion rate was measured using a differential thermal expansion meter. The average linear expansion coefficient was calculated by dividing the expansion rate of the test sample measured from room temperature to 450° C. by the value of the temperature change.

A plate-like test sample with dimensions of 25 mm×25 mm and a thickness of 0.3 to 1 mm was cut out and both sides thereof were polished. Then, the light transmission spectrum was measured and the absorption coefficient at 355 nm was calculated. The absorption coefficient a was calculated from the transmittance T1 of a test sample with a thickness of d1 and the transmittance T2 of a test sample with a thickness of d2 according to the above-mentioned Lambert's Law.

In order to examine the micromachinability of each glass, both sides of the plate-like test sample with a thickness of 0.3 mm were polished, and the third harmonic (having a wavelength of 355 nm) of an Nd:YAG laser having a pulse width of 24 ns was condensed through a fθ lens with a focal length of 100 mm so as to irradiate the test sample with a laser power of 0.4 to 2.8 W from thereabove.

The test sample irradiated with the laser beam was cut, the cut surface was polished, and the polished cut surface was observed with an optical microscope. If the altered phase is formed, it can be confirmed visually because the refractive index of the altered phase area is different from that of the surrounding portion or the color of the altered phase area is different from that of the surrounding portion due to coloration.

When a glass is irradiated with a high power laser beam, a portion around the laser irradiation spot on the laser beam incoming or outgoing surface or both of the surfaces may be damaged. When a value of laser power at which the portion around the irradiation spot begins to be damaged is called a damage threshold, the damage threshold varies depending on the glass composition.

When the glass is irradiated with a laser beam so as to form the altered phase, it is preferable that the altered phase can be formed as long as possible in the optical axis direction of the laser and, in addition, the portion around the laser beam irradiation spot is not damaged.

In view of the above, the abilities of forming the altered phase in the glass of all Examples and Comparative Examples to be described later were evaluated according to the following criteria. Evaluation results are shown in Table 1.
(1) A considerably long altered phase (approximately 70% or more of the thickness of the glass plate) was formed when the glass plate was irradiated with a laser power of the damage threshold or less ( [symbol] );
(2) A long altered phase (approximately 50% or more of the thickness of the glass plate) was formed when the glass plate was irradiated with a laser power of the damage threshold or less (◯);
(3) A short altered phase (approximately less than 50%, at most, of the thickness of the glass plate) was formed when the glass plate was irradiated with a laser power of the damage threshold or less, but a long altered phase (approximately 50% or more of the thickness of the glass plate) was formed when it was irradiated with a laser power of the damage threshold or more (Δ);
(4) An altered phase hardly was formed when the glass plate was irradiated with a laser power of the damage threshold or less, and a short altered phase (approximately less than 50%, at most, of the thickness of the glass plate) was formed even when it was irradiated with a laser power of the damage threshold or more (x); and
(5) An altered phase hardly was formed even when the glass plate was irradiated with a laser power of the damage threshold or more (xx).

In the present embodiment, the upper limit of the laser power is 2.8 W for the reasons of the laser apparatus, and each glass plate was evaluated according to the above criteria, based on the result obtained when it was irradiated with a laser power in a range up to 2.8 W.

It is seen from Table 1 that the glasses of Examples 1 to 18 containing metal oxides as colorants each have an excellent ability of forming the altered phase. Particularly, the glasses of Examples 2 and 6 to 12 each have a high altered phase forming ability. On the other hand, the glass of Comparative Example 1 containing no metal oxide as a colorant was evaluated as “x”. The glass of Comparative Example 2, which is a quartz glass, was evaluated as “xx”, the worst rank, under the laser irradiation conditions of the present embodiment.

### Examples 19 to 32 and Comparative Example 3

In Examples 19 to 32, glasses each having the above-mentioned aluminosilicate glass-based base composition (2) were used. The glasses of Examples 19 to 32 contain metal oxides as colorants, but the glass of Comparative Example 3 contains no metal oxide as a colorant. Raw materials were prepared so that the glass compositions indicated in Table 2 were obtained, and the glasses were obtained in the same manner as in the glasses of above-mentioned Examples. These glasses were evaluated in the same manner as described above.

TABLE 2

| | | | | | | | | Exam- | Exam- | Exam- | Exam- | Exam- |
|---|---|---|---|---|---|---|---|---|---|---|---|---|
| | Example | Example | Example | Example | Example | Example | Example | ple | ple | ple | ple | ple |
| Components | 19 | 20 | 21 | 22 | 23 | 24 | 25 | 26 | 27 | 28 | 29 | 30 |
| SiO₂ | 65.1 | 65.1 | 65.1 | 65.1 | 65.1 | 65.1 | 66.6 | 66.6 | 66.6 | 66.6 | 65.3 | 65.3 |
| B₂O₃ | 6.4 | 6.4 | 6.4 | 6.4 | 6.4 | 6.4 | 0.0 | 0.0 | 0.0 | 0.0 | 0.0 | 0.0 |
| Al₂O₃ | 12.8 | 12.8 | 12.8 | 12.8 | 12.8 | 12.8 | 15.7 | 15.7 | 15.7 | 15.7 | 15.4 | 15.4 |
| MgO | 4.9 | 4.9 | 4.9 | 4.9 | 4.9 | 4.9 | 0.5 | 0.5 | 0.5 | 0.5 | 0.5 | 0.5 |
| ZnO | 5.6 | 5.6 | 5.6 | 5.6 | 5.6 | 5.6 | 15.2 | 15.2 | 15.2 | 15.2 | 14.9 | 14.9 |
| Li₂O | 5.2 | 5.2 | 5.2 | 5.2 | 5.2 | 5.2 | 0.0 | 0.0 | 0.0 | 0.0 | 2.0 | 2.0 |
| Na₂O | 0.0 | 0.0 | 0.0 | 0.0 | 0.0 | 0.0 | 2.0 | 2.0 | 2.0 | 2.0 | 0.0 | 0.0 |
| K₂O | 0.0 | 0.0 | 0.0 | 0.0 | 0.0 | 0.0 | 0.0 | 0.0 | 0.0 | 0.0 | 2.0 | 2.0 |
| SnO₂ | 0.0 | 0.0 | 0.0 | 0.0 | 0.0 | 0.0 | 0.2 | 0.0 | 0.0 | 0.5 | 0.2 | 0.5 |
| CeO₂ | 0.1 | 0.2 | 0.3 | 0.4 | 0.0 | 0.0 | 0.0 | 0.1 | 0.2 | 0.0 | 0.0 | 0.0 |
| Fe₂O₃ | 0.0 | 0.0 | 0.0 | 0.0 | 0.06 | 0.1 | 0.0 | 0.0 | 0.0 | 0.0 | 0.0 | 0.0 |
| Absorption | 1.8 | 3.4 | 3.6 | 9.2 | 5.6 | 9.1 | 0.5 | 2.1 | 3.7 | 0.6 | 0.5 | 0.6 |
| coefficient (cm⁻¹) | | | | | | | | | | | | |
| Linear | 37 | 37 | 37 | 37 | 37 | 37 | 34 | 34 | 34 | 32 | 34 | 35 |
| expansion | | | | | | | | | | | | |
| coefficient | | | | | | | | | | | | |
| (10⁻⁷/K⁻¹) | | | | | | | | | | | | |
| Formation of | [symbol] | [symbol] | [symbol] | ∘ | [symbol] | ∘ | Δ | Δ | ∘ | Δ | Δ | Δ |
| altered phase | | | | | | | | | | | | |

| | | | | | | | | | | Comp. | Comp. |
|---|---|---|---|---|---|---|---|---|---|---|---|
| | Example | Example | Comp. | Comp. | Comp. | Comp. | Comp. | Comp. | Comp. | Example | Example |
| Components | 31 | 32 | Example 3 | Example 4 | Example 5 | Example 6 | Example 7 | Example 8 | Example 9 | 10 | 11 |
| SiO₂ | 65.3 | 65.3 | 65.1 | 66.6 | 66.6 | 66.6 | 66.6 | 66.6 | 66.6 | 66.6 | 66.6 |
| B₂O₃ | 0.0 | 0.0 | 6.4 | 0.0 | 0.0 | 0.0 | 0.0 | 0.0 | 0.0 | 0.0 | 0.0 |
| Al₂O₃ | 15.4 | 15.4 | 12.8 | 15.7 | 15.7 | 15.7 | 15.7 | 15.7 | 15.7 | 15.7 | 15.7 |
| MgO | 0.5 | 0.5 | 4.9 | 15.7 | 13.7 | 11.7 | 9.7 | 7.7 | 5.7 | 3.7 | 0.5 |
| ZnO | 14.9 | 14.9 | 5.6 | 0.0 | 2.0 | 4.0 | 6.0 | 8.0 | 10.0 | 12.0 | 15.2 |
| Li₂O | 2.0 | 2.0 | 5.2 | 0.0 | 0.0 | 0.0 | 0.0 | 0.0 | 0.0 | 0.0 | 0.0 |
| Na₂O | 0.0 | 0.0 | 0.0 | 2.0 | 2.0 | 2.0 | 2.0 | 2.0 | 2.0 | 2.0 | 2.0 |
| K₂O | 2.0 | 2.0 | 0.0 | 0.0 | 0.0 | 0.0 | 0.0 | 0.0 | 0.0 | 0.0 | 0.0 |
| SnO₂ | 1.0 | 1.5 | 0.0 | 0.0 | 0.0 | 0.0 | 0.0 | 0.0 | 0.0 | 0.0 | 0.0 |
| CeO₂ | 0.0 | 0.0 | 0.0 | 0.0 | 0.0 | 0.0 | 0.0 | 0.0 | 0.0 | 0.0 | 0.0 |
| Fe₂O₃ | 0.0 | 0.0 | 0.0 | 0.0 | 0.0 | 0.0 | 0.0 | 0.0 | 0.0 | 0.0 | 0.0 |
| Absorption | 0.7 | 0.7 | 0.2 | 0.2 | 0.2 | 0.2 | 0.3 | 0.3 | 0.3 | 0.4 | 0.4 |
| coefficient (cm⁻¹) | | | | | | | | | | | |
| Linear | 35 | 36 | 37 | 39 | 38 | 37 | 37 | 36 | 34 | 32 | 29 |
| expansion | | | | | | | | | | | |
| coefficient | | | | | | | | | | | |
| (10⁻⁷/K⁻¹) | | | | | | | | | | | |
| Formation of | Δ | Δ | Δ | x | x | x | x | x | x | x | x |
| altered phase | | | | | | | | | | | |

It is seen from Table 2 that the glasses of Examples 19 to 32 containing metal oxides as colorants each have an excellent ability of forming the altered phase. Although the glasses of Examples 19 to 24 and the glass of Comparative Example 3 have the same base glass composition, the altered phase forming abilities of the glasses of Examples 19 to 24 were evaluated as “◯” or “ [symbol] ”, which were higher than the evaluation of the glass of Comparative Example 3 as “Δ”. Particularly in each of the glasses of Examples 19 to 21, a long altered phase (270 μm or longer) extending almost through the glass could be formed without damaging the portion around the laser beam irradiation spot. On the other hand, the glasses of Comparative Examples 4 to 11 were evaluated as “x”.

Each glass test sample with the altered phase formed therein by the laser beam was subjected to the following etching treatment. As an etchant, 2.3 mass % hydrofluoric acid was used.

The glass sample with a thickness of about 0.3 mm, which had been irradiated with a laser beam under the laser power condition of 1 W, was immersed in the etchant, and allowed to stand at room temperature for 2 hours while the etchant was being stirred as appropriate. Then, the glass sample was taken out of the etchant, and washed well with water. After the test sample was dried, the cross section of the sample was observed with an optical microscope.

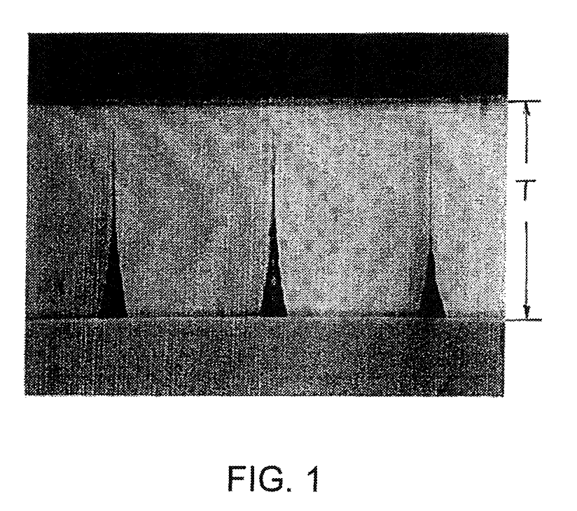

FIG. 1 is a photograph showing the cross section of the glass of Example 5, observed with an optical microscope after the glass was irradiated with a laser beam and etched. This photograph shows that long conical holes having a high aspect ratio are formed. In FIG. 1, “T” denotes the thickness of the glass.

On the other hand, the glass of Comparative Example 1 was irradiated with a laser beam and etched under the same condition, but no micro-hole was formed therein, unlike in the case of the glass of Example 5.

1. A glass for anodic bonding having a base glass composition containing 1 to 6 mol % of Li₂O+Na₂O+K₂O and having an average linear expansion coefficient of 32×10⁻⁷ K⁻¹ to 39×10⁻⁷ K⁻¹ in a temperature range of room temperature to 450° C.,
wherein the glass further contains 0.01 to 5 mol % of a metal oxide as a colorant relative to the base glass composition, and
the glass has an absorption coefficient of 0.5 to 50 cm⁻¹ at a particular wavelength within 535 nm or less.

2. The glass for anodic bonding according to claim 1, wherein the base glass composition comprises, in terms of mol %:
80 to 85% of SiO₂;
10 to 15% of B₂O₃;
0 to 5% of Al₂O₃;
0 to 5% of CaO+MgO+SrO+BaO+ZnO; and
1 to 6% of Li₂O+Na₂O+K₂O.

3. The glass for anodic bonding according to claim 2, wherein:
the base glass composition comprises, in terms of mol %:
82 to 83% of SiO₂;
11 to 12% of B₂O₃;
1 to 2% of Al₂O₃; and
4 to 5% of Li₂O+Na₂O+K₂O, and
the average linear expansion coefficient is 32×10⁻⁷ K⁻¹ to 34×10⁻⁷ K⁻¹.

4. The glass for anodic bonding according to claim 1, wherein the base glass composition comprises, in terms of mol %:
60 to 70% of SiO₂;
0 to 8% of B₂O₃;
10 to 16% of Al₂O₃;
5 to 20% of CaO+MgO+SrO+BaO+ZnO; and
1 to 6% of Li₂O+Na₂O+K₂O.

5. The glass for anodic bonding according to claim 4, wherein:
the base glass composition comprises, in terms of mol %:
65 to 67% of SiO₂;
10 to 16% of Al₂O₃;
15 to 16% of MgO+ZnO; and
2 to 4% of Li₂O+Na₂O+K₂O, and
the average linear expansion coefficient is 32×10⁻⁷ K⁻¹ to 36×10⁻⁷ K⁻¹.

6. The glass for anodic bonding according to claim 1, wherein the colorant is at least one metal oxide selected from the group consisting of tin oxide, cerium oxide, iron oxide, titanium oxide, vanadium oxide, chromium oxide, manganese oxide, cobalt oxide, molybdenum oxide, tungsten oxide, and bismuth oxide.

7. The glass for anodic bonding according to claim 1, wherein the colorant is at least one metal oxide selected from the group consisting of tin oxide, cerium oxide, and iron oxide.

8. A method of producing a glass for anodic bonding having a micro-hole, the method comprising the steps of:
producing the glass for anodic bonding according to claim 1 as a glass plate;
irradiating a laser beam onto a surface of the glass plate so as to form an altered phase; and
wet-etching the glass with the altered phase formed therein so as to form a micro-hole in the glass.
